(19) United States
(12) Patent Application Publication
(10) Pub. No.: US 2022/0398315 A1
(43) Pub. Date: Dec. 15, 2022

(54) Determining a Malware Defense Profile Using Machine Learning

(71) Applicant: Bank of America Corporation, Charlotte, NC (US)

(72) Inventors: Michael Robert Young, Davidson, NC (US); Tomas Mata Castrejon, III, Fort Mill, SC (US); Rick Wayne Sumrall, Chralotte, NC (US)

(21) Appl. No.: 17/345,770

(22) Filed: Jun. 11, 2021

(51) Int. Cl. G06F 21/56; G06F 21/55; G06N 20/00

(52) U.S. Cl. CPC G06F 21/564; G06F 21/552; G06F 21/568; G06N 20/00; G06F 2221/033

(57) ABSTRACT

According to certain embodiments, a network security device comprises a memory operable to store testing options for testing malware behavior and a processor operably coupled to the memory. The processor is configured to intercept probes sent by a malware application and to test a set of test responses, each test response corresponds to a respective one of the testing options that comprises information that the probe seeks to obtain. For each test response, the test determines a test result indicating whether the test response resulted in stopping detonation of the malware application. Information indicating the test result and the test response that yielded the test result is input into a machine learning model configured to determine a malware defense profile based on the test information and to output the malware defense profile.

### TECHNICAL FIELD The present disclosure relates generally to network security, and more specifically to determining a malware defense profile using machine learning.

### BACKGROUND

In a network environment, devices are in data communication with other devices that may be distributed anywhere in the world. These network environments allow data and information to be shared among devices. Some of the technical challenges that occur when data is exchanged between devices include preventing malicious activities, such as malware attacks. Device vulnerability to malware attacks poses several network security challenges. Existing systems may be unable to detect or mitigate certain malware attacks.

### SUMMARY

The system disclosed in the present application provides a technical solution to the technical problems discussed above by leveraging machine learning to determine how to respond to a probe sent by a malware application in a manner that prevents the malware application from detonating. The disclosed system provides several practical applications and technical advantages which include a process for testing a set of test responses to the probe sent by the malware application in order to determine which responses prevent the malware application from detonating. This process provides a practical application by improving the network security of the system by allowing the system to identify responses that stop the malware application from performing malicious actions. This means that the system is able to protect the data and devices within the network and to prevent a bad actor from performing malicious activities. The disclosed system also provides another practical application that includes a process for leveraging machine learning to generate a malware defense profile indicating how to respond to the probe in order to prevent the malware application from detonating. The malware defense profile may be sent to user devices to protect the user devices from malware attacks. These processes allow the system to detect and prevent unauthorized access to data and other network security vulnerabilities within the network. Certain embodiments leverage machine learning to observe and address malware behavior changes that may occur over time. For example, if the malware application evolves to try to evade detection, the machine learning may observe the change and may update the malware defense profile accordingly. In this manner, certain embodiments protect against evolving malware threats.

These practical applications not only improve the network security of the system, they also improve the underlying network and the devices within the network. When a malware attack occurs, there may be an increase in the number of device resources consumed, which degrades performance of the device. For example, a malware attack may cause spikes in processor usage and/or memory usage. When a malware attack occurs, there may be an increase in the number of network resources consumed, which reduces the throughput of the network. For example, a malware attack may attempt to exfiltrate data through the network, thereby consuming network bandwidth. By preventing malware attacks, the system is able to prevent any unnecessary increases in the number of device resources, the number of network resources, and/or bandwidth that are consumed that would otherwise negatively impact the system. As another example, when a malware attack occurs, one or more devices within the network may be taken out of service until the malware can be removed from the devices. Taking devices out of service negatively impacts the performance and throughput of the network because the network has fewer resources for processing and communicating data. By preventing malware types of attacks, the system prevents any comprised devices from being taken out of service due to an attack that would otherwise negatively impact the performance and throughput of the network.

In one embodiment, a network security device comprises a memory operable to store a plurality of testing options for testing malware behavior and a processor operably coupled to the memory. The processor is configured to determine that a malware application is configured to send a probe that seeks to obtain information associated with an environment in which the malware application runs and to determine a set of test responses. Each test response corresponds to a respective one of the testing options that comprises the information that the probe seeks to obtain. For each test response in the set of test responses, the processor is configured to perform a test of the test response. To perform the test, the processor is configured to initiate running the malware application in a test environment, intercept the probe sent by the malware application, provide the malware application with the test response, determine a test result indicating whether the test response resulted in stopping detonation of the malware application, and input into a machine learning model test information indicating the test result and the test response that yielded the test result. The machine learning model is configured to receive the test information associated with each test response and determine a malware defense profile based on the test information. The malware defense profile indicates one or more attributes of the test responses that resulted in stopping detonation of the malware application. The machine learning model is further configured to output the malware defense profile.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a network security system;

FIG. 2 is a flowchart of an embodiment of a malware defense profile determination process for the network security system;

FIG. 3 is a flowchart of an embodiment of a malware defense profile application process for the network security system;

FIG. 4 is an embodiment of a hardware configuration for a device of the network security system.

### DETAILED DESCRIPTION

Certain embodiments of the present disclosure may facilitate defending against malware attacks. A malware application may look for certain characteristics on a host that the malware application is going to infect. For example, a malware application may make certain system calls to determine whether it is running on a virtual machine or bare metal (a standalone, physical machine, as opposed to a virtual machine). The malware application may be designed to react different depending on whether it is running on a virtual machine or a physical machine. For example, the malware application may be designed such that when it detects characteristics related to a virtual environment it does not act, but when it detects characteristics related to a physical environment, it acts to infect the physical machine. Embodiments of the present disclosure may intercept system calls made by the malware application and may respond in a manner that makes the malware application think that it is running on a virtual machine when it is actually running on a physical machine, or vice versa. Certain embodiments intercept those system calls at a low enough level of the kernel so as to respond to the malware application in a way that the malware application would not be able to determine that it is being made to think that it is running on a different type of machine than the type of machine that it is actually running on.

Embodiments that make the malware application think that it is running on a physical machine when it is actually running on a virtual machine may be used to test the malware application in a virtual environment in order to learn behavior of the malware application, for example, using machine learning. With respect to a malware application that lacks the ability to infect a virtual machine, testing may be performed safely in the virtual environment. Thus, testing in a virtual environment may allow for more robust testing of the malware application. Robust testing may allow for detecting how the malware determines whether it is running in a virtualized environment. For example, the testing may test various responses to various types of probes sent by the malware application, which may include system calls and/or other probes, to observe how the malware application reacts. Additionally, testing the malware application in a virtual environment may facilitate more efficient testing. As a technical advantage, certain embodiments may spin up a number of virtual machines (e.g., 10 virtual machines, 20 virtual machines, or other suitable number of virtual machines) to be able to test multiple instances of the malware application in parallel. If the malware application stops responding to a test performed in one of the virtual machines (e.g., because the malware application learns that it has been detected by a malware defense system), the system can spin up a new virtual machine to start a new test. For example, the new test may repeat certain aspects of the previous test and may change a portion of the previous test that may have caused the malware to stop responding. Spinning up a number of virtual machines is relatively low-cost in the virtual machine world. But, to have to reformat the same number of physical machines would be much more time consuming. Certain embodiments may test differences in malware application depending on whether the malware application thinks it is running on a virtual machine or a physical machine. This may be used to determine suspicious behavior of the malware application, which may in turn be used to detect future instances of the malware application (e.g., by creating or updating a fingerprint associated with behavior of the malware application). As one example, detecting that an automatic teller machine (ATM) application is running in a virtual environment may be a flag that a malware application has launched an attack.

Embodiments that make the malware application think that it is running on a virtual machine when it is actually running on a physical machine may be used to protect the physical machine from being infected by the malware application. Because certain malware applications are designed not to act in a virtual environment, making such a malware application think that it is running on the virtual machine prevents the malware application from launching an attack.

### System Overview

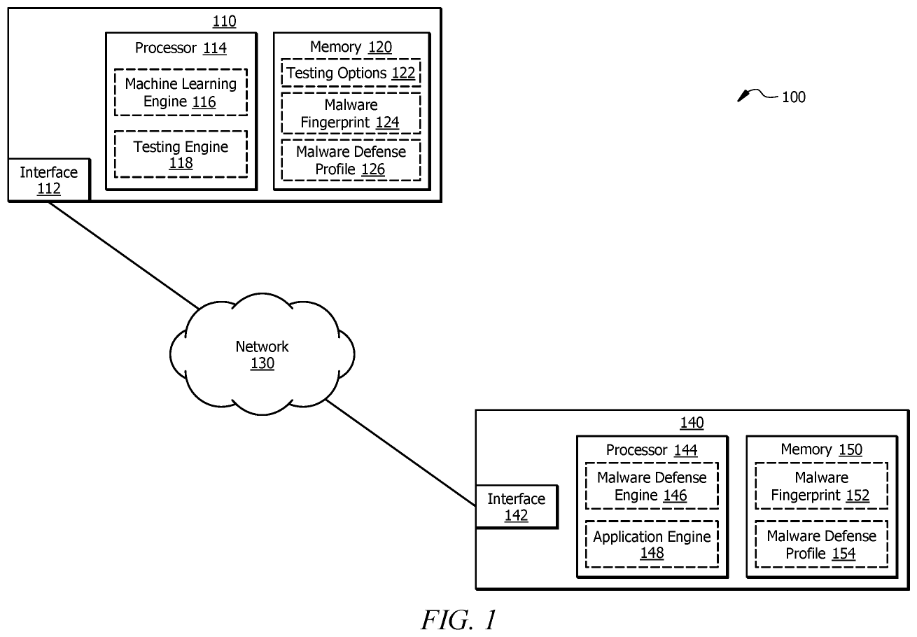

FIG. 1 is a schematic diagram of an embodiment of a system 100 that is configured to provide network security. In one embodiment, system 100 comprises a network security device 110 and one or more devices 140 that are in signal communication with each other over a network 130. In general, network security device 110 intercepts one or more probes sent by a malware application and performs testing of various test responses in order to determine which test responses stop detonation of the malware application. Network security device 110 inputs test information obtained from the testing into a machine learning model configured to determine a malware defense profile 126 based on the test information. The malware defense profile 126 indicates one or more attributes of the test response that resulted in stopping detonation of the malware application. The machine learning model is further configured to output the malware defense profile 126. In certain embodiments, the machine learning model outputs the malware defense profile via a network interface that communicates the malware defense profile to device 140 via network 130. Device 140 may store malware defense profile 126 (e.g., as malware defense profile 154) for use by device 140.

In general, device 140 uses the malware defense profile 154 to defend against a malware attack. Device 140 intercepts a probe sent by a malware application and determines a response to send to the malware application based on the malware defense profile 154. For example, device 140 selects an attribute of the malware defense profile 154 that comprises a type of information that the probe seeks to obtain and is configured to prevent detonation of the malware application. By preventing detonation of the malware application, device 140 prevents the malware application from performing malicious actions that may damage device 140, compromise data stored or accessed by device 140, or otherwise interfere with operation of device 140.

### Network Security Device

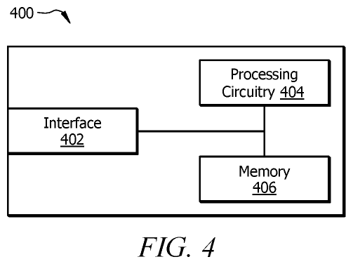

Examples of the network security device 110 include, but are not limited to, a server, a computer, or any other suitable type of network device. Network security device 110 may comprise interface 112, processor 114, and/or memory 120. Examples of interface 112, processor 114, and/or memory 120 are further described below with respect to FIG. 4. Interface 142 facilitates communicating with device 140 via network 130. For example, network security device 110 may communicate via interface 112 in order to output a malware defense profile 126 to device 140.

Processor 114 comprises a machine learning engine 116 and a testing engine 118. Machine learning engine 116 may apply a machine learning model to determine the malware defense profile based on testing information obtained by testing engine 118. Examples of machine learning models include, but are not limited to, a multi-layer perceptron, a recurrent neural network (RNN), an RNN long short-term memory (LSTM), or any other suitable type of neural network model.

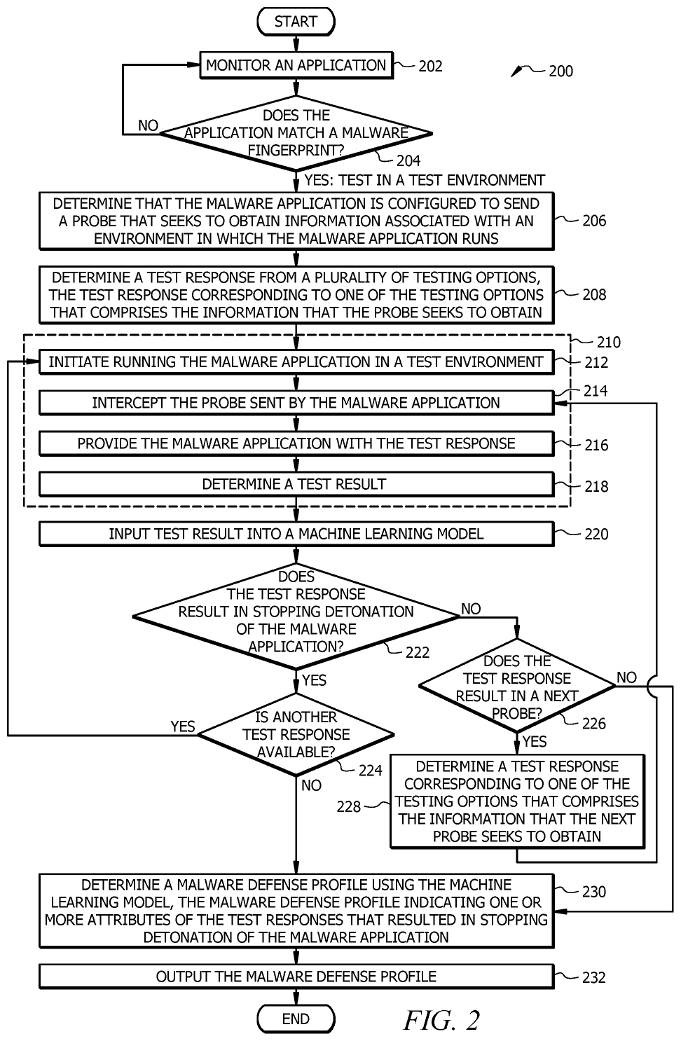

Testing engine 118 may perform testing to determine behavior of a malware application. For example, testing engine 118 may perform certain steps of process 200 of FIG. 2 (such as steps 202-228). To facilitate testing the malware application, testing engine 118 may be configured to access one or more testing options 122 and one or more malware fingerprints 124 stored in memory 120. In certain embodiments, testing engine 118 uses the malware fingerprints 124 to detect a malware application. Testing engine 118 determines that the malware application is configured to send a probe that seeks to obtain information associated with an environment in which the malware application runs. Testing engine 118 determines a set of test responses. Each test response corresponds to a respective one of the testing options 122 that comprises the information that the probe seeks to obtain. For each test response in the set of test responses, testing engine 118 is configured to perform a test of the test response. To perform the test, testing engine 118 is configured to initiate running the malware application in a test environment, intercept the probe sent by the malware application, provide the malware application with the test response, determine a test result indicating whether the test response resulted in stopping detonation of the malware application, and input into a machine learning model test information indicating the test result and the test response that yielded the test result. The machine learning model, which may be included in machine learning engine 116, is configured to receive the test information associated with each test response and determine a malware defense profile 126 based on the test information. The malware defense profile 126 indicates one or more attributes of the test responses that resulted in stopping detonation of the malware application. The machine learning model is further configured to output the malware defense profile.

### Devices

In certain embodiments, a device 140 may be a user device, such as a smartphone, a wearable device (such as a smartwatch), a Internet-of-Things (IoT) device, a tablet, a laptop, a computer, or any other suitable type of user device. A user device may be associated with a user and is generally configured to provide access to data, applications, and network resources for the user. As an example, a user device may be associated with an employee and configured to provide the employee access to a company's data and resources. As another example, a user device may be associated with a customer and configured to provide the customer access to a service provider's data and resources. A user device may include applications accessed by a user, such as email applications, social media applications, word processing applications, online banking applications, and/or other suitable applications. For example, device 140 may comprise an application engine 148 configured to run such applications. Applications run by application engine 148 may comprise “real-life” applications, as opposed to test environment applications. Although certain embodiments describe device 140 as a user device, in other embodiments, device 140 may more generally refer to any device operable to perform the functionality described as being performed by a device 140. For example, in certain embodiments, device 140 may be a sever.

Device 140 may comprise interface 142, processor 144, and/or memory 150. Examples of interface 142, processor 144, and/or memory 150 are further described below with respect to FIG. 4. Interface 142 facilitates communicating with network security device 110 via network 130. For example, device 140 may communicate via interface 142 in order to obtain from network security device 110 a malware defense profile 126 (which device 140 may store as malware defense profile 154).

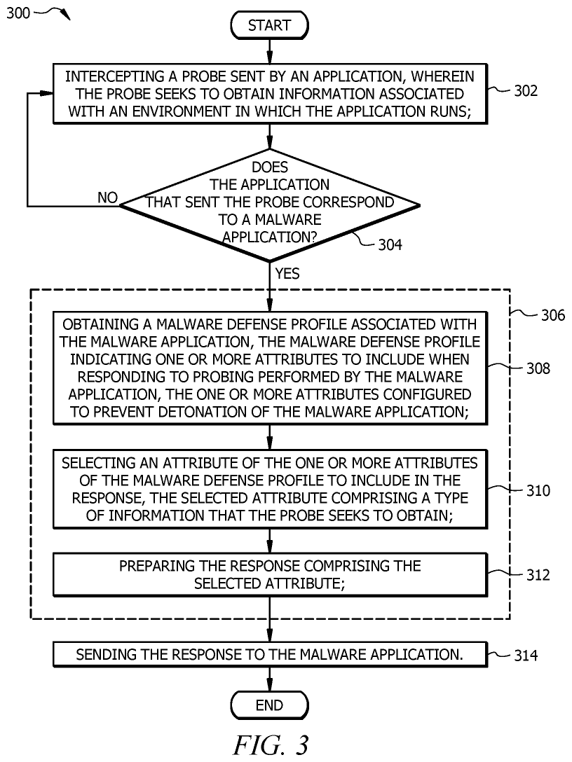

Processor 144 comprises a malware defense engine 146. Malware defense engine 146 may perform actions to defend against malware. For example, malware defense engine 146 may perform process 300 of FIG. 3. To facilitate defending against malware, malware defense engine 144 may be configured to access one or more malware fingerprints 152 and/or one or more malware defense profiles 154 stored in memory 150. The malware defense profile 154 indicates one or more attributes to include when responding to probing performed by the malware application. The one or more attributes are configured to prevent detonation of the malware application.

In certain embodiments, malware defense engine 146 intercepts a probe sent by an application. The probe seeks to obtain information associated with an environment in which the application runs. Malware defense engine 146 determines whether the application that sent the probe corresponds to the malware application, for example, based on comparing the information or behavior associated with the application to one or more malware fingerprints 152 stored in memory 150. In response to determining that the application that sent the probe corresponds to the malware application, malware defense engine 146 determines a response to send the malware application in order to respond to the probe. To determine the response, malware defense engine 146 obtains the malware defense profile 154 associated with the malware application and selects an attribute of the malware defense profile 154 to include in the response. The selected attribute comprises a type of information that the probe seeks to obtain, and the selected attribute prevents detonation of the malware application. Malware defense engine 146 prepares the response comprising the selected attribute and sends the response to the malware application.

### Network

Network 130 may be any suitable type of wireless and/or wired network including, but not limited to, all or a portion of the Internet, an Intranet, a private network, a public network, a peer-to-peer network, the public switched telephone network, a cellular network, a local area network (LAN), a metropolitan area network (MAN), a personal area network (PAN), a wide area network (WAN), and a satellite network. Network 130 may be configured to support any suitable type of communication protocol as would be appreciated by one of ordinary skill in the art.

### Malware Defense Profile Determination Process

FIG. 2 illustrates an example of a malware defense profile 126 determination process 200. In certain embodiments, process 200 may be performed by network security device 110 of FIG. 1. In certain embodiments, process 200 begins at step 202 with monitoring an application. In certain embodiments, process 200 monitors an application running on network security device 110. For example, network security device 110 may receive an application to be monitored for suspicious behavior and may monitor the application.

At step 204, process 200 determines whether the application matches a malware fingerprint 124. Process 200 may determine that the application matches a malware fingerprint 124 based on determining that the malware application comprises one or more features associated with the malware fingerprint 124. Examples of features associated with the malware fingerprint 124 may include a malware signature, suspicious system behavior, suspicious user behavior (such as behavior that purports to be performed by a user, but is actually performed by malware), or suspicious characteristics. Examples of suspicious system behavior may include an unusual increase in processor usage, unusual memory usage, or unusual system calls. Examples of suspicious user behavior may include running the application at an usual time of day (such as 3:00 am) or interacting with the application in an unusual manner (such as hesitating over windows or clicking a mouse at speeds that deviate from typical behavior of a good actor). Examples of suspicious characteristic may include a suspicious user identifier, screen resolution, geolocation, etc.

In response to determining at step 204 that the application does not match the malware fingerprint 124, process 200 may optionally end, or process 200 may return to step 202 to continue monitoring the application. Thus, if the malware fingerprint 124 becomes updated or if the application behavior changes, process 200 may reassess whether the application matches the malware fingerprint 124. In response to determining at step 204 that the application matches the malware fingerprint 124 (e.g., based on determining that the malware application comprises one or more features associated with the malware fingerprint 124), process 200 may determine to run testing of the malware application in a test environment in order to learn the behavior of the malware application. Process 200 may proceed to step 206 to run testing of the malware application. In an alternative embodiment, process 200 may begin at step 206 (omitting steps 202 and 204). For example, network security device 110 may receive an application that a system administrator or another device has identified as a malware application, and network security device 110 may proceed directly to testing the malware application.

At step 206, process 200 determines that the malware application is configured to send a probe. As an example, process 200 may initiate running the malware application and may monitor for a probe sent by the malware application. The probe seeks to obtain information associated with an environment in which the malware application runs. As an example, the probe may seek to obtain information that indicates to the malware application whether malware application is running in a virtual environment or a physical environment. As another example, the probe may seek to obtain one or more attributes of an operating system on which the malware application is running. Such attributes may include a type of operating system (such as Android, Apple iOS, Linux, macOS, Microsoft Windows, Web OS, etc.) and/or operating system version. As another example, the probe may seek to obtain resource information associated with an environment in which the malware application is running. Examples of resource information may include one or more resource identifiers and/or information indicating configuration or availability of one or more resources. Examples of resource identifiers may include an Internet Protocol (IP) address, a Medium Access Control (MAC) identifier, a Network Interface Card (NIC) identifier, a port identifier, a central processing unit (CPU) identifier, processor ID, process ID, etc. Examples of resource configuration may include memory configuration. Examples of resource availability may include whether the malware application has access to a resource, such as an Internet connection (e.g., to contact a remote “home” server of the malware application or otherwise facilitate an attack), or whether access to the resource is blocked (e.g. by a firewall). A malware application may make system calls to try to determine such information. As another example, the probe may seek to obtain information about As another example, the probe may seek to obtain user level data associated with the environment in which the malware application is running. User level data generally refers to data accessible to a user (as opposed to lower level data within a device). For example, a malware application designed to transact an unauthorized financial transaction may seek to obtain user level data indicating an amount of funds available in a financial account targeted for the unauthorized transaction. In certain embodiments, user level data may be communicated by an application layer.

Process 200 proceeds to step 208 with determining a set of test responses. Each test response may be selected from a plurality of testing options 122 stored in memory of network security device 110. The testing options 122 may be based on configurations used by various devices 140 that obtain security assistance from network security device 110. For example, devices 140 may include a mix of smartphones, laptop computers, personal computers, and so on, and testing options 122 may be based on different configurations used by these different types of devices. The test responses allow network security device 110 to mimic behavior of the various devices 140 that obtain security assistance from network security device 110 in order to test how the malware application responds.

Each test response determined in step 208 corresponds to a respective one of the testing options 122 that comprises the information that the probe seeks to obtain. As an example, suppose the testing options 122 include operating system type options (e.g., Android, Apple iOS, Linux, macOS, Microsoft Windows, Web OS, etc.), operating system version options (e.g., version 1, version 2, version 3, etc.), resource identifier options, such as IP address options (e.g., IP address 1, IP address 2, IP address 3, etc.), MAC ID options (e.g., MAC ID 1, MAC ID 2, MAC ID 3, etc.), NIC options (NIC 1, NIC 2, NIC 3, etc.), and/or port ID options (e.g., port 1, port 2, port 3, etc.), user level data options (e.g., user level data option 1, user level data option 2, etc.), and/or other suitable testing options 122. If the probe seeks to obtain information about a type of operating system running the malware application, a first test response comprising the information that the probe seeks to obtain may indicate an Android operating system, and a second test response comprising the information that the probe seeks to obtain may indicate an Apple iOS operating system.

Process 200 proceeds to step 210 where, for each test response in the set of test responses determined in step 208, process 200 performs a test of the test response. In certain embodiments, each of the test responses to include in the set may be determined prior to performing any testing. For example, process 200 may determine each testing option 122 that is responsive to the probe and may include test responses associated with each such testing option 122 in the set of test responses. Process 200 may then proceed with testing the first test response, then the second test response, and so on until each test response in the set has been tested. In other embodiments, the test responses to include in the set may be determined dynamically. As an example, process 200 may test a first test response and may then determine to add a second test response to the set based on a test result of testing the first test response. In this manner, process 200 may determine to continue testing different test responses until process 200 identifies a test response that yields a certain test result (such as stopping the malware application from detonating), without necessarily having to test a test response for every testing option 122 that is responsive to the probe. Thus, the set of test responses tested by process 200 might not necessarily include a test response for every testing option 122 that is responsive to the probe. As an example, suppose the probe seeks to obtain information about an operating system version running the malware application. In certain embodiments, process 200 may determine that the set of test responses includes test responses associated with a first version and a second version, but that the set of test responses does not include a test response associated with a third version.

In certain embodiments, the test performed in step 210 may comprise performing steps 212-220 for each test response in the set of test responses. At step 212, process 200 initiates running the malware application in the test environment. The test environment allows for observing the behavior of the malware application in a controlled setting that protects the underlying system from the malware application. For example, the test environment may correspond to a virtual environment. In certain embodiments, one or more of the test responses may indicate to the malware application that the malware application is running in a physical environment (as opposed to the virtual environment that the malware application is actually running in) in order to encourage the malware application to keep running so that network security device 110 can learn the behavior of the malware application. At step 214, process 200 intercepts the probe sent by the malware application. At step 216, process 200 provides the malware application with the test response. At step 218, process 200 determine a test result indicating whether the test response resulted in stopping detonation of the malware application. For example, the malware application may be designed to exploit a vulnerability associated with a certain type of environment in which the malware application is running. Thus, the malware application may be probing in an attempt to discover a particular operating system type, operating system version, resource (e.g., IP address, MAC ID, NIC, port ID), or other attribute associated with the vulnerability. If the test response indicates that the environment contains the vulnerability, the malware application may determine to detonate or to take actions toward detonation. If the test response indicates that the environment does not contain the vulnerability, the malware application may determine not to detonate. At step 220, process 200 inputs into a machine learning model test information indicating the test result and the test response that yielded the test result.

Process 200 may repeat steps 212-220 any suitable number of times in order to test each test response in the set of test responses. For example, in certain embodiments, the method proceeds to step 222 with determining whether the test response tested in steps 212-220 resulted in stopping detonation of the malware application. In response to determining that the test response resulted in stopping detonation, process 200 proceeds to step 224 to determine if another test response is available. For example, process 200 may determine if there are any further test responses that are responsive to the probe and that have not yet been tested, such as a next test response in the set of test responses or a next test response to be added to the set of test responses (in embodiments that determine the set of test responses dynamically). In response to determining that the next test response is available, process 200 may perform the test on the next test response by repeating steps 212-220 using the next test response. This technique may act as a honeypot to learn more about the behavior of the malware application. For example, if one of the test responses causes the malware application to stop, process 200 can test another test response to try to get the malware application to continue running so that process 200 can learn what additional probes the malware application is configured to send and/or actions that the malware application is configured to perform.

In an embodiment, process 200 comprises selecting a first test response from the plurality of testing options 122 (step 208), performing the test of the first test response to yield a first test result (step 210, comprising steps 212-220), determining that the first test result indicates that the first test response resulted in stopping detonation of the malware application (step 222, “yes” branch), in response selecting a second test response from the plurality of testing options 122 (step 224), and performing the test of the second test response to yield a second test result (return to step 210, comprising steps 212-220). As an example, suppose that the probe sent by the malware seeks port information. The first test response may indicate a first port. The malware application may stop upon receiving the test response indicating the first port, for example, if the malware application does not detect any vulnerability associated with the first port. The second test response may indicate a second port so that network security device 110 can learn if the malware application detects a vulnerability associated with the second port and, if so, how the malware application behaves.

If process 200 determines at step 222 that the test response resulted in stopping detonation, if process 200 determines at step 224 that there is not another test response available, the method may skip to step 230 (discussed below).

If process 200 determines at step 222 that the test response did not result in stopping detonation, process 200 may proceed to step 226 to determine whether the malware application sends a next probe. If no, process 200 may skip to step 230 (discussed below). If yes, process 200 may proceed to step 228 to determine a test response corresponding to one of the testing options 122 that comprises the information that the next probe seeks to obtain. Process 200 may then return to step 214 to test the test response responsive to the next probe. Process 200 may repeat the test as needed to test different test responses that are responsive to the next probe. For example, process 200 may provide a first test response responsive to a first probe in order to cause the malware application to send the second probe. Process 200 may then provide a second test response responsive to the second probe. If the second test response stops the malware application, process 200 may re-initiate running the malware application, provide a first test response responsive to a first probe in order to cause the malware application to send the second probe, and provide a third test response responsive to the second probe.

In an embodiment, process 200 selects a first test response from the plurality of testing options 122 (step 208), performs the test of the first test response to yield a first test result (step 210, comprising steps 212-220), and determines that the first test result indicates that the first test response resulted in the malware application sending a second probe that seeks to obtain additional information associated with the environment in which the malware application runs (step 226, “yes” branch). As one example, the first probe may seek an operating system type and the second probe may seek an operating system version. In response, process 200 determines a second test response from the plurality of testing options 122 (step 228). The second test response corresponds to one of the testing options 122 that comprises the additional information that the second probe seeks to obtain. Process 200 returns to step 214 with intercepting the second probe sent by the malware application, then to step 216 with providing the malware application with the second test response, then to step 218 with determining a second test result indicating whether the second test response resulted in stopping detonation of the malware application, and then to step 220 with inputting into the machine learning model second test information indicating the second test result and the second test response that yielded the second test result. In certain embodiments, the input into the machine learning may indicate a relationship between the first test information and the second test information. For example, the second test information indicate that the combination of the first response to the first probe and the second response to the second probe yielded the second test results.

As discussed above, process 200 inputs test information indicating test results and test responses that yielded the test results in a machine learning model (and, thus, machine learning model receives the test information associated with each test response as a result of step 220). At step 230, process 200 uses the machine learning model to determine a malware defense profile 126 associated with the malware application. The malware defense profile 126 is determined based on the test information. The malware defense profile 126 indicates one or more attributes of the test responses that resulted in stopping detonation of the malware application. In certain embodiments, the malware defense profile 126 indicates combinations of attributes that resulted in stopping detonation of the malware application. For example, the malware defense profile 126 may indicate that the combination of operating system X and version 1 caused the malware application to detonate, however, the combination of operating system X and version 2 stopped the malware application from detonating. The malware defense profile 126 may combine any suitable number and type of attributes, for example, depending on the behavior of the malware application observed during the testing.

At step 234, process 200 outputs the malware defense profile 126. In an embodiment, process 200 outputs the malware defense profile 126 to memory of network security device 110. As an example, this may allow network security device 110 to retrieve and update the malware defense profile 126 (e.g., if new types of devices 140 associated with new testing options 122 are added to the network of devices 140 that network security device 110 assists with network security). In addition, or in the alternative, process 200 may output the malware defense profile 126 to a system administrator or industry advisor or law enforcement in order to alert the system administrator or industry advisor or law enforcement about the behavior of the malware application. In addition, or in the alternative, process 200 may output the malware defense profile 126 to an engine that creates or updates malware fingerprint 124 and/or 152. For example, the malware defense profile 126 may indicate the types and/or sequences of probes that a malware application sends. Creating or updating malware fingerprints 124 and/or 152 to indicate malware behavior may facilitate identifying when the malware application is running on a device so that the device can defend against the malware application. In addition, or in the alternative, process 200 may output the malware defense profile 126 to a malware defense module configured to use the malware defense profile 126 to prevent the malware application from detonating in a user environment. The malware defense module may be part of network security device 110 or part of a device 140. For example, in certain embodiments, process 200 outputs the malware defense profile 126 to one or more devices 140 (e.g., via network 130) so that device 140 can use the malware defense profile 126 to protect against a malware attack, as described with respect to FIG. 3.

As described above, process 200 may be adapted to respond to various types of probes sent by the malware application. In an embodiment, the probe seeks to obtain information indicating an attribute of an operating system associated with the environment in which the malware application runs. The set of test responses may comprise a first test response indicating to the malware application that the malware application is running on an operating system having a first attribute and a second test response indicating to the malware application that the malware application is running on an operating system having a second attribute, the second attribute different than the first attribute. In an embodiment, the probe seeks to obtain information indicating a resource identifier associated with the environment in which the malware application runs. The set of test responses comprises a first test response indicating a first resource identifier and a second test response indicating a second resource identifier, the second resource identifier different than the first resource identifier. In an embodiment, the probe seeks to obtain information indicating user level data associated with the environment in which the malware application runs. The set of test responses comprises a first test response indicating first user level data and a second test response indicating second user level data, the second user level data different than the first user level data. As an example, the malware application may be designed to transact an unauthorized financial transaction and may seek to obtain user level data indicating an amount of funds available in a financial account targeted for the unauthorized transaction. The first test response may indicate that the financial account contains $10 and the second test response may indicate that the financial account contains $1,000. The machine learning model may learn that responding with $10 causes the malware application not to detonate and that responding with $1,000 causes the malware application to detonate.

### Malware Defense Profile Application Process

FIG. 3 illustrates an example of a malware defense profile application process 300. In certain embodiments, process 300 may be performed by network security device 110 or by device 140 of FIG. 1. The network security device 110 or device 140 performing the process 300 may comprise a memory operable to store a malware defense profile 126 or 154 associated with a malware application, such as the malware defense profile 126 or 154 generated in FIG. 2. The malware defense profile 126 or 154 indicates one or more attributes to include when responding to probing performed by the malware application. The one or more attributes are configured to prevent detonation of the malware application.

Process 300 begins at step 302 with intercepting a probe sent by an application. The probe seeks to obtain information associated with an environment in which the application runs. Process 300 continues to step 304 with determining whether the application that sent the probe corresponds to the malware application. In certain embodiments, process 300 determines whether the application that sent the probe corresponds to the malware application based on determining that the malware application comprises one or more features associated with a malware fingerprint 124 or 152. Examples of features associated with the malware fingerprint 124 or 152 may include a malware signature, suspicious system behavior, suspicious user behavior (such as behavior that purports to be performed by a user, but is actually performed by malware), or suspicious characteristics. Examples of suspicious system behavior may include an unusual increase in processor usage, unusual memory usage, or unusual system calls. Examples of suspicious user behavior may include running the application at an usual time of day (such as 3:00 am) or interacting with the application in an unusual manner (such as hesitating over windows or clicking a mouse at speeds that deviate from typical behavior of a good actor). Examples of suspicious characteristic may include a suspicious user identifier, screen resolution, geolocation, etc.

In response to determining at step 304 that the application does not match the correspond to the malware application, process 300 may optionally end, or process 300 may return to step 302 to continue monitoring the application. Thus, if the malware fingerprint 124 or 152 becomes updated or if the application behavior changes, process 300 may reassess whether the application corresponds to the malware application. In response to determining at step 304 that the application corresponds to the malware application (e.g., based on determining that the malware application comprises one or more features associated with the malware fingerprint 124 or 152), process 300 may determine a response to send to the malware application, as indicated by step 306. Step 306 may comprise steps 308-312.

At step 308, process 300 obtains the malware defense profile 126 or 154 associated with the malware application. Certain embodiments obtain the malware defense profile 126 or 154 from memory (e.g., when running process 30 using network security device 110, the malware defense profile 126 may be obtained from memory 120; when running process 300 using device 140, the malware defense profile 154 may be obtained from memory 150). Certain embodiments obtain the malware defense profile via network 130 (e.g., when running process 300 using device 140, the malware defense profile 126 may be obtained from network security device 110 via network 130). In certain embodiments, the malware defense profile 126 or 154 may be one of a plurality of malware defense profiles, each malware defense profile 126 or 154 associated with a respective malware application. Certain embodiments may determine which malware defense profile 126 or 154 is associated with the malware application that sent the probe of step 302, for example, based on a malware signature or malware fingerprint 124 or 152.

Process 300 proceeds to step 310 with selecting an attribute of the one or more attributes of the malware defense profile 126 or 154 to include in the response to the probe. As described above, the one or more attributes of the malware defense profile 126 or 154 are configured to prevent detonation of the malware application. The selected attribute comprises a type of information that the probe seeks to obtain.

As an example, if the probe seeks to obtain information about an operating system associated with the environment in which the malware application runs, then the selected attribute indicates operating system information that prevents detonation of the malware application. Examples of operating system information may include operating system type (e.g., Android, Apple iOS, Linux, macOS, Microsoft Windows, Web OS, etc.), operating system version (e.g., version 1, version 2, version 3, etc.), etc.

As another example, if the probe seeks to obtain information indicating a resource identifier associated with the environment in which the malware application runs, then the selected attribute indicates a resource identifier that prevents detonation of the malware application. Examples of resource identifiers include IP addresses (e.g., IP address 1, IP address 2, IP address 3, etc.), MAC IDs (e.g., MAC ID 1, MAC ID 2, MAC ID 3, etc.), NICs (e.g., NIC 1, NIC 2, NIC 3, etc.), port IDs (e.g., port 1, port 2, port 3, etc.), and so on. For example, in some cases, a malware application may be designed to behave differently depending on whether a resource identifier, such as a MAC ID, indicates that the device on which the malware application is running is located in a particular country, such as the United States. Thus, in the example, the resource identifier that prevents detonation of the malware application may be a resource identifier, such as a MAC ID, indicating that the device on which the malware application is running is located in a country that is of no interest to the malware application, such as a country other than the United States. In another example, for a case in which the probe seeks an IP address, the response may include an IP address that belongs to law enforcement in order to prevent detonation of the malware application.

As another example, if the probe seeks to obtain information indicating user level data associated with the environment in which the malware application runs, then the selected attribute indicates user level data that prevents detonation of the malware application. User level data generally refers to data accessible to a user (as opposed to lower level data within a device). For example, a malware application designed to transact an unauthorized financial transaction may seek to obtain user level data indicating an amount of funds available in a financial account targeted for the unauthorized transaction. In certain embodiments, user level data may be communicated by an application layer. At step 312, process 300 prepares the response to the probe intercepted at step 302. The response comprises the selected attribute determined in step 310. In certain embodiments, the response to the malware application provides false information associated with the environment in which the malware application runs in order to prevent the malware application from learning true information associated with the environment in which the malware application runs. For example, the false information may prevent the malware application from detonating and may prevent the malware application from learning true information that would cause the malware application to detonate. In an embodiment, the environment in which the application runs corresponds to a physical environment, and the response to the malware application indicates that the application is running in a virtual environment. Thus, the response to the malware application provides false information (that the malware application runs in a virtual environment) in order to prevent the malware application from learning true information (that the malware application runs in a physical environment).

At step 314, process 300 sends the response to the malware application. In certain embodiments, process 300 may perform further steps to defend against the malware application. As an example, process 300 may contain the malware application to prevent future malicious actions by the malware application.

### Hardware Configuration

FIG. 4 is an embodiment of a hardware configuration 400 that may be used in implementing network security device 110 or device 140 described above with respect to FIG. 1. As an example, hardware configuration 400 comprises interface 402, processing circuitry 404, and memory 406, which may be used in implementing network security device 110′s interface 112, processor 114, and memory 120, respectively. Network security device 110 may be configured as shown or in any other suitable configuration. As another example, interface 402, processing circuitry 404, and memory 406 may be used in implementing device 140′s interface 142, processor 144, and memory 150, respectively. Device 140 may be configured as shown or in any other suitable configuration.

### Processing Circuitry

The processing circuitry 404 comprises one or more processors operably coupled to the memory 406. The processing circuitry 404 is any electronic circuitry including, but not limited to, state machines, one or more central processing unit (CPU) chips, logic units, cores (e.g. a multi-core processor), field-programmable gate array (FPGAs), application-specific integrated circuits (ASICs), or digital signal processors (DSPs). The processing circuitry 404 may be a programmable logic device, a microcontroller, a microprocessor, or any suitable combination of the preceding. The processing circuitry 404 is communicatively coupled to and in signal communication with the memory 406 and the network interface 402. The one or more processors are configured to process data and may be implemented in hardware or software. For example, the processing circuitry 404 may be 8-bit, 16-bit, 32-bit, 64-bit, or of any other suitable architecture. The processing circuitry 404 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The one or more processors are configured to implement various instructions. As an example, with respect to network security device 110, the one or more processors are configured to execute instructions to implement machine learning engine 116 and/or testing engine 118. As an example, with respect to device 140, the one or more processors are configured to execute instructions to implement malware defense engine 146 and/or application engine 148. In this way, processing circuitry 404 may be a special-purpose computer designed to implement the functions disclosed herein. In an embodiment, an engine may be implemented using logic units, FPGAs, ASICs, DSPs, or any other suitable hardware. The machine learning engine 116, testing engine 118, malware defense engine 146, and/or application engine 148 are configured to operate as described above, for example, with respect to FIG. 1. In certain embodiments, machine learning engine 116 and testing engine 118 may perform certain steps of FIG. 2, such as steps 230-232, and steps 202-228, respectively. In certain embodiments, malware defense engine 146 may perform the steps of FIG. 3.

### Memory

The memory 406 is operable to store any of the information described above with respect to FIGS. 1-3 along with any other data, instructions, logic, rules, or code operable to implement the function(s) described herein when executed by the processing circuitry 404. The memory 406 comprises one or more disks, tape drives, or solid-state drives, and may be used as an over-flow data storage device, to store programs when such programs are selected for execution, and to store instructions and data that are read during program execution. The memory 406 may be volatile or non-volatile and may comprise a read-only memory (ROM), random-access memory (RAM), ternary content-addressable memory (TCAM), dynamic random-access memory (DRAM), and static random-access memory (SRAM).

In certain embodiments, with respect to network security device 110, memory 406 is operable to store testing options 122, malware fingerprint 124, malware defense profile 126, and/or any other data or instructions. In certain embodiments, with respect to device 140, memory 406 is operable to store malware fingerprint 152, malware defense profile 154, and/or any other data or instructions.

### Network Interface

The network interface 402 is configured to enable wired and/or wireless communications. The network interface 402 is configured to communicate data between network security device 110, devices 140, and other devices, systems, or domains. For example, the network interface 402 may comprise a near-field communication (NFC) interface, a Bluetooth interface, a Zigbee interface, a Z-wave interface, a radio-frequency identification (RFID) interface, a WIFI interface, a LAN interface, a WAN interface, a PAN interface, a modem, a switch, or a router. The processing circuitry 404 is configured to send and receive data using the network interface 402. The network interface 402 may be configured to use any suitable type of communication protocol as would be appreciated by one of ordinary skill in the art.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A network security device, the network security device comprising:
a memory operable to store a plurality of testing options for testing malware behavior; and
a processor operably coupled to the memory, the processor configured to:
determine that a malware application is configured to send a probe that seeks to obtain information associated with an environment in which the malware application runs;
determine a set of test responses, each test response corresponding to a respective one of the testing options that comprises the information that the probe seeks to obtain;
for each test response in the set of test responses, perform a test of the test response, wherein to perform the test the processor is configured to:
initiate running the malware application in a test environment;
intercept the probe sent by the malware application;
provide the malware application with the test response;
determine a test result indicating whether the test response resulted in stopping detonation of the malware application; and
input into a machine learning model test information indicating the test result and the test response that yielded the test result;
wherein the machine learning model is configured to:
receive the test information associated with each test response;
determine, based on the test information, a malware defense profile associated with the malware application, the malware defense profile indicating one or more attributes of the test responses that resulted in stopping detonation of the malware application; and
output the malware defense profile.

2. The network security device of claim 1, wherein to determine the set of test responses, the processor is further configured to:
select a first test response from the plurality of testing options;
perform the test of the first test response to yield a first test result;
determine that the first test result indicates that the first test response resulted in stopping detonation of the malware application;
in response to the first test result indicating that the first test response resulted in stopping detonation of the malware application, select a second test response from the plurality of testing options; and
perform the test of the second test response to yield a second test result.

3. The network security device of claim 1, wherein to determine the set of test responses, the processor is further configured to:
select a first test response from the plurality of testing options;
perform the test of the first test response to yield a first test result; and
determine that the first test result indicates that the first test response resulted in the malware application sending a second probe that seeks to obtain additional information associated with the environment in which the malware application runs;
wherein, in response to the first test result, the processor is further configured to:
select a second test response from the plurality of testing options, the second test response corresponding to one of the testing options that comprises the additional information that the second probe seeks to obtain;
intercept the second probe sent by the malware application;
provide the malware application with the second test response;
determine a second test result indicating whether the second test response resulted in stopping detonation of the malware application; and
input into the machine learning model second test information indicating the second test result and the second test response that yielded the second test result.

4. The network security device of claim 1, wherein the processor is further configured to:
determine to run testing of the malware application in the test environment based on determining that the malware application comprises one or more features associated with a malware fingerprint.

5. The network security device of claim 1, wherein the test environment corresponds to a virtual environment and wherein at least one of the test responses indicates to the malware application that the malware application is running in a physical environment.

6. The network security device of claim 1, wherein:
the probe seeks to obtain information indicating an attribute of an operating system associated with the environment in which the malware application runs;
a first test response of the set of test responses indicates to the malware application that the malware application is running on an operating system having a first attribute; and
a second test response of the set of test responses indicates to the malware application that the malware application is running on an operating system having a second attribute, the second attribute different than the first attribute.

7. The network security device of claim 1, wherein:
the probe seeks to obtain information indicating resource information associated with the environment in which the malware application runs;
a first test response of the set of test responses indicates first resource information; and
a second test response of the set of test responses indicates second resource information, the second resource information different than the first resource information.

8. The network security device of claim 1, wherein:
the probe seeks to obtain information indicating user level data associated with the environment in which the malware application runs;
a first test response of the set of test responses indicates first user level data; and
a second test response of the set of test responses indicates second user level data, the second user level data different than the first user level data.

9. The network security device of claim 1, wherein the malware defense profile is output to a malware defense module configured to use the malware defense profile to prevent the malware application from detonating in a user environment.

10. A network security method, comprising:
determining that a malware application is configured to send a probe that seeks to obtain information associated with an environment in which the malware application runs;
determining a set of test responses, each test response in the set of test responses determined from a plurality of testing options based on the test response comprising the information that the probe seeks to obtain;
for each test response in the set of test responses, performing a test of the test response, wherein performing the test comprises:
initiating running the malware application in a test environment;
intercepting the probe sent by the malware application;
providing the malware application with the test response;
determining a test result indicating whether the test response resulted in stopping detonation of the malware application; and
inputting into a machine learning model test information indicating the test result and the test response that yielded the test result;
wherein the network security method further comprises:
determining, by the machine learning model, a malware defense profile associated with the malware application, the malware defense profile determined based on the test information associated with each test response, the malware defense profile indicating one or more attributes of the test responses that resulted in stopping detonation of the malware application; and
outputting the malware defense profile.

11. The network security method of claim 10, wherein determining the set of test responses comprises:
selecting a first test response from the plurality of testing options;
performing the test of the first test response to yield a first test result;
determining that the first test result indicates that the first test response resulted in stopping detonation of the malware application;
in response to the first test result indicating that the first test response resulted in stopping detonation of the malware application, selecting a second test response from the plurality of testing options; and
performing the test of the second test response to yield a second test result.

12. The network security method of claim 10, wherein determining the set of test responses comprises:
selecting a first test response from the plurality of testing options;
performing the test of the first test response to yield a first test result; and
determining that the first test result indicates that the first test response resulted in the malware application sending a second probe that seeks to obtain additional information associated with the environment in which the malware application runs;
wherein, in response to the first test result, the network security method further comprises:
selecting a second test response from the plurality of testing options, the second test response corresponding to one of the testing options that comprises the additional information that the second probe seeks to obtain;
intercepting the second probe sent by the malware application;
providing the malware application with the second test response;
determining a second test result indicating whether the second test response resulted in stopping detonation of the malware application; and
inputting into the machine learning model second test information indicating the second test result and the second test response that yielded the second test result.

13. The network security method of claim 10, further comprising:
determining to run testing of the malware application in the test environment based on determining that the malware application comprises one or more features associated with a malware fingerprint.

14. The network security method of claim 10, wherein the test environment corresponds to a virtual environment and wherein at least one of the test responses indicates to the malware application that the malware application is running in a physical environment.

15. A computer program product comprising executable instructions stored in a non-transitory computer-readable medium that when executed by a processor causes the processor to perform actions comprising:
determining that a malware application is configured to send a probe that seeks to obtain information associated with an environment in which the malware application runs;
determining a set of test responses, each test response in the set of test responses determined from a plurality of testing options based on the test response comprising the information that the probe seeks to obtain;
for each test response in the set of test responses, performing a test of the test response, wherein performing the test comprises:
initiating running the malware application in a test environment;
intercepting the probe sent by the malware application;
providing the malware application with the test response;
determining a test result indicating whether the test response resulted in stopping detonation of the malware application; and
inputting into a machine learning model test information indicating the test result and the test response that yielded the test result;
wherein the actions further comprise:
determining, by the machine learning model, a malware defense profile associated with the malware application, the malware defense profile determined based on the test information associated with each test response, the malware defense profile indicating one or more attributes of the test responses that resulted in stopping detonation of the malware application; and
outputting the malware defense profile.

16. The computer program product of claim 15, wherein determining the set of test responses comprises:
selecting a first test response from the plurality of testing options;
performing the test of the first test response to yield a first test result;
determining that the first test result indicates that the first test response resulted in stopping detonation of the malware application;
in response to the first test result indicating that the first test response resulted in stopping detonation of the malware application, selecting a second test response from the plurality of testing options; and
performing the test of the second test response to yield a second test result.

17. The computer program product of claim 15, wherein determining the set of test responses comprises:
selecting a first test response from the plurality of testing options;
performing the test of the first test response to yield a first test result; and
determining that the first test result indicates that the first test response resulted in the malware application sending a second probe that seeks to obtain additional information associated with the environment in which the malware application runs;
wherein, in response to the first test result, the actions further comprise:
selecting a second test response from the plurality of testing options, the second test response corresponding to one of the testing options that comprises the additional information that the second probe seeks to obtain;
intercepting the second probe sent by the malware application;
providing the malware application with the second test response;
determining a second test result indicating whether the second test response resulted in stopping detonation of the malware application; and
inputting into the machine learning model second test information indicating the second test result and the second test response that yielded the second test result.

18. The computer program product of claim 15, the actions further comprising:
determining to run testing of the malware application in the test environment based on determining that the malware application comprises one or more features associated with a malware fingerprint.

19. The computer program product of claim 15, wherein the test environment corresponds to a virtual environment and wherein at least one of the test responses indicates to the malware application that the malware application is running in a physical environment.

20. The computer program product of claim 15, wherein:
a first test response of the set of test responses indicates a first attribute of a first attribute type, the first attribute type based on the information that the probe seeks to obtain; and
a second test response of the set of test responses indicates a second attribute of the first attribute type, the second attribute different than the first attribute;
wherein the first attribute type corresponds to an attribute of an operating system, a resource identifier, or user level data.
